(19) United States
(12) Patent Application Publication
(10) Pub. No.: US 2023/0259197 A1
(43) Pub. Date: Aug. 17, 2023

(54) A Virtual Reality System

(71) Applicant: VirtuReal Pty Ltd, Red Hill (AU)

(72) Inventor: Jeremy Taylor Orr, Red Hill (AU)

(73) Assignee: VirtuReal Pty Ltd, Red Hill (AU)

(21) Appl. No.: 18/014,204

(22) PCT Filed: Jul. 2, 2021
(86) PCT No.: PCT/AU2021/050711

§ 371 Date: Jan. 3, 2023

(30) Foreign Application Priority Data
Jul. 2, 2020 (AU) 2020902261

(51) Int. Cl. G06F 3/01; G06T 7/246; G06T 7/73; G06T 15/00

(52) U.S. Cl. CPC G06F 3/012; G06F 3/016; G06T 7/246; G06T 7/73; G06F 3/013; G06T 15/00; G06F 2203/012; G06T 2207/30204

(57) ABSTRACT

A virtual reality system having a head mounted display for producing images of a virtual environment on the display, a tracking system configured to track the movements of a user and the head mounted display, and one or more wearable haptic components for providing haptic feedback. The system has a computer system that is programmed to generate a virtual environment for display on the head mounted display and a virtual user in the virtual environment corresponding to the user, respond to the tracking system and thereby control the head mounted display and virtual user movements to produce images of the virtual environment corresponding to tracking data from the tracking system, and control the one or more haptic components to generate a haptic effect in response to the tracking data from the tracking system and events in the virtual environment.

### TECHNICAL FIELD

The present invention relates to a virtual reality system. In particular, the invention relates to an immersive and adaptive movement tracking virtual reality system that allows substantially free roaming within a virtual space by a user.

### BACKGROUND

Any references to methods, apparatus or documents of the prior art are not to be taken as constituting any evidence or admission that they formed, or form, part of the common general knowledge.

Virtual reality headsets and display devices are commonly used to visually simulate a user's physical presence in a virtual space using portable electronic display technology (e.g. small screens).

These virtual reality headsets allow users to have a 360° view of the virtual space they are inhabiting by turning or moving their head, which is detected by the virtual reality headset and display device, and results in the image on display being adjusted to match the movements of the user's head.

Some virtual reality systems can also track the movements of the user's hands and feet such that the user can move about the virtual space and interact with it. However, many virtual spaces often have greater physical dimensions than the dimensions of the physical space the user is occupying (such as a room in their home, for example) and thus the enjoyment or efficacy of the virtual reality experience can be hindered.

Many existing VR systems give users handheld controllers (e.g. one controller in each hand) and other unnatural control interfaces which are not conducive to training and do not accurately emulate real-life scenarios. In one example, existing systems provide combatants with controllers designed to be used in place of weaponry.

### Object

It is an aim of this invention to provide a virtual reality system which overcomes or ameliorates one or more of the disadvantages or problems described above, or which at least provides a useful commercial alternative.

Other preferred objects of the present invention will become apparent from the following description.

### SUMMARY OF THE INVENTION

According to a first embodiment of the present invention, there is provided a virtual reality system comprising:
a head mounted display for producing images of a virtual environment on the display;
a tracking system configured to track the movements of a user and the head mounted display;
one or more wearable haptic components for providing haptic feedback; and
a computer system that is programmed to:
   generate a virtual environment for display on the head mounted display and a virtual user in the virtual environment corresponding to the user;
   respond to the tracking system and thereby control the head mounted display and virtual user movements to produce images of the virtual environment corresponding to tracking data from the tracking system; and
   control the one or more haptic components to generate a haptic effect in response to the tracking data from the tracking system and events in the virtual environment.

According to a second embodiment of the present invention, there is provided a virtual reality system comprising:
a head mounted display for producing images of a virtual environment on the display;
a tracking system configured to track the movements of a user and the head mounted display;
one or more wearable haptic components for providing haptic feedback;
an omnidirectional treadmill; and
a computer system that is programmed to:
   generate a virtual environment for display on the head mounted display and a virtual user in the virtual environment corresponding to the user;
   respond to the tracking system and thereby control the head mounted display and virtual user movements to produce images of the virtual environment corresponding to tracking data from the tracking system;
   control the one or more haptic components to generate a haptic effect in response to tracking data from the tracking system and events in the virtual environment; and
   control the omnidirectional treadmill in response to tracking data from the tracking system.

According to a third embodiment of the present invention, there is provided a virtual reality system comprising:
a head mounted display for producing images of a virtual environment on the display;
one or more wearable haptic components for providing haptic feedback;
an omnidirectional treadmill;
a replica firearm or replica device;
a tracking system configured to track the movements of a user, the head mounted display and the replica firearm or replica device; and
a computer system that is programmed to:
   generate a virtual environment for display on the head mounted display and a virtual user in the virtual environment corresponding to the user;
   respond to the tracking system and thereby control the head mounted display and virtual user movements to produce images of the virtual environment corresponding to tracking data from the tracking system;
   control the one or more haptic components to generate a haptic effect in response to tracking data from the tracking system and events in the virtual environments;
   control the omnidirectional treadmill in response to tracking data from the tracking system; and
   communicate with the replica firearm or replica device to thereby receive signals from the replica firearm or replica device and control the replica firearm or replica device in response to the signals and events in the virtual environment.

According to a fourth embodiment of the present invention, there is provided a virtual reality system comprising:
a head mounted display for producing images of a virtual environment on the display;
one or more wearable haptic components for providing haptic feedback;
an omnidirectional treadmill;
a replica firearm or replica device;
a tracking system configured to track the movements of a user, the head mounted display and the replica firearm or replica device, the tracking system comprising:
   at least three tracking markers, wherein a first tracking marking is attachable to a user, a second tracking marker is attached to the replica firearm or replica device and a third tracking marker is attached to the head mounted display; and
   one or more sensors configured to track the one or more tracking markers to generate tracking data corresponding to position and movement of the tracking markers; and
a computer system that is programmed to:
   generate a virtual environment for display on the head mounted display and a virtual user in the virtual environment corresponding to the user;
   respond to the tracking system and thereby control the head mounted display and virtual user movement to produce images of the virtual environment corresponding to the tracking data from the tracking system;
   control the one or more haptic components to generate a haptic effect in response to the tracking data from the tracking system and events in the virtual environment;
   control the omnidirectional treadmill in response to the tracking data from the tracking system; and
   communicate with the replica firearm or replica device to thereby receive signals from the replica firearm or replica device and control the replica firearm or replica device in response to the signals and events in the virtual environment.

Preferably, movement of the tracking markers comprises generating position and rotation data corresponding to the movement of the tracking markers.

According to another embodiment of the present invention, there is provided a method for controlling a virtual reality system, the method comprising the steps of:
generating a virtual environment and a virtual user in the virtual environment based on a user in a physical space;
tracking a three dimensional position of the user in the physical space;
generating tracking data associated with the three dimensional position of the user in the physical space; and
controlling one or more wearable haptic components worn by the user to generate a haptic effect in response to the tracking data from the tracking system and events in the virtual environment.

According to another embodiment of the present invention, there is provided a method for controlling a virtual reality system, the method comprising the steps of:
generating a virtual environment and a virtual user in the virtual environment based on a user in a physical space;
generating first tracking data associated with the three dimensional position of the user in the physical space
tracking a three dimensional position of a user on an omnidirectional treadmill interacting with the virtual environment;
generating third tracking data associated with a replica device of the user and receiving signals from the replica device;
detecting user interaction with elements of the virtual environment based on the first tracking data, the second tracking data and the third tracking data;
controlling the omnidirectional treadmill in response to the first tracking data and keep the user substantially centred on the omnidirectional treadmill;
controlling one or more wearable haptic components worn by the user to generate a haptic effect in response to the second tracking data from the tracking system and events in the virtual environment; and
controlling the replica firearm or replica device in response to the third tracking data, the signals and events in the virtual environment.

Preferably, the method includes tracking movement of the user on an omnidirectional treadmill interacting with the virtual environment; and controlling the omnidirectional treadmill in response to the movement of the user to keep the user substantially centred on the omnidirectional treadmill.

Preferably, the method includes tracking a three dimensional position of a replica device and/or a physical object; generating second tracking data associated with the replica device and/or the physical object and receiving signals from the replica device and/or the physical object; detecting user interaction with at least one of the replica device, the physical object and elements of the virtual environment based on the second tracking data; controlling the replica device and/or the physical object in response to the second tracking data, the received signals and the user interaction; and controlling the virtual environment in response to the second tracking data, the received signals and the user interaction.

Preferably, the method includes controlling one or more wearable haptic components worn by the user to generate a haptic effect in response to the second tracking data from the tracking system and the user interaction.

Preferably, there is provided a plurality of virtual reality systems as described above, wherein the plurality of virtual reality systems are networked to allow users to experience a shared virtual environment based on the virtual environment. Preferably, the plurality of virtual reality systems are networked via a Local Area Network (LAN) and/or a Wide Area Network (WAN).

Preferably, the one or more wearable haptic components comprise a full body suit and gloves, each having haptic feedback devices integrated therein. Preferably, the full body suit is adapted to cover the arms, chest, legs and back of a user. Preferably, the full body suit is wireless and is in wireless communication with the computer system.

Preferably, the tracking system is configured to track at least one of the arms, torso, legs and fingers of the user. More preferably, the tracking system is configured to track each of the arms, torso, legs and fingers of the user.

Preferably, the computer system comprises a first computer connected to the head mounted display, each of the one or more wearable haptic components and the omnidirectional treadmill. Preferably, the first computer is also connected to the replica firearm and/or one or more replica devices.

Preferably, the first computer is additionally connected to the tracking system to receive the tracking data.

Preferably, the computer system comprises a second computer connected to the tracking system to receive the tracking data. Preferably, the first computer and the second computer are in electrical communication for exchanging data.

Preferably, the one or more wearable haptic components further comprise motion capture sensors. Preferably, the one or more wearable haptic components further comprise temperature simulation devices configured to generate heat and/or cold. Preferably, the one or more wearable haptic components further comprise force feedback devices.

Preferably, the system further comprises a replica firearm. Preferably, the replica firearm comprises an electromagnetic recoil system.

Preferably, the system further comprises one or more replica devices. Preferably, the one or more replica devices comprise a replica flashbang or replica medical tool having electronic inputs and outputs.

Preferably, the system further comprises an olfactory device attached to the head mounted display, the olfactory device being configured to emit one or more scents in response to user movements and/or events in the virtual environment.

Preferably, the wearable haptic components, the head mounted display and/or the replica device comprise tracking markers for tracking by the tracking system to produce tracking data. Preferably, the tracking markers comprise optical tracking markers. Preferably, the optical tracking markers comprise optical tracking pucks. Preferably, the optical tracking markers comprise active optical tracking markers (i.e. not passive).

Preferably, the tracking system is further configured to track eye movements of a user wearing the head mounted display. Preferably, eye movements are tracked via the head mounted display.

Preferably, the computer system is programmed to receive biometric data from biometric sensors of the one or more wearable haptic components. Preferably, the computer system is programmed to receive motion capture data from motion capture sensors of the one or more wearable haptic components. Preferably, the one or more wearable haptic components comprise a pair of haptic gloves and a haptic suit. In some embodiments, the gloves may not have any haptic feedback or capabilities. Preferably, the computer system is programmed to receive sensor data from one or more interactable elements of the replica firearm. Preferably, the interactable elements comprise buttons, switches and/or slide mechanisms. Preferably, the computer system is programmed to control the virtual environment in response to one or more of the biometric data, the motion capture data, and the sensor data.

Preferably, the system comprises one or more physical objects in a physical space. Preferably, the one or more physical objects comprise one or more tracking markers attached thereto. Preferably, the computer generates virtual objects in the virtual environment corresponding to the one or more physical objects in the physical space. Preferably, the tracking systems tracks the tracking markers attached to the physical objects. Preferably, the computer is configured to detect user interaction with the physical objects and control the one or more wearable haptic components in response. More preferably, the computer is configured to control the virtual objects in the virtual environment in response to events in the virtual environment.

Preferably, the system further comprises a support system. Preferably, the support system comprises an overhead support system.

Preferably, the tracking system comprises a plurality of tracking sub-systems, the plurality of tracking sub-systems comprising a first tracking sub-system configured to track the head mounted display and the movement and position of the user and/or a second tracking sub-system configured to track movement of the one or more wearable haptic components and/or a third tracking sub-system configured to track eye movements of the user.

Preferably, the second tracking sub-system tracks motion sensors embedded in the one or more wearable haptic components and generates motion sensor data therefrom.

According to another embodiment of the present invention, there is provided a virtual reality system comprising:
a head mounted display for producing images of a virtual environment on the display;
a tracking system configured to track the movements of a user;
a computer that is programmed to respond to the tracking system and thereby control the head mounted display to produce images of the virtual environment corresponding to tracking data from the tracking system.

Further features and advantages of the present invention will become apparent from the following detailed description.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description make reference to a number of drawings as follows:

FIGS. 1-3 illustrates overhead, side and front views of a virtual reality system according to an embodiment of the present invention;

FIG. 4 illustrates a front view of a virtual reality system according to a second embodiment of the present invention;

FIG. 5 illustrates an overhead view of a virtual reality system according to another embodiment of the present invention;

FIGS. 6 and 7 illustrate views of a physical space having physical structures and omnidirectional treadmills for use with embodiments of the present invention;

FIGS. 8 and 8′ illustrate schematic of a virtual reality system according to an embodiment of the present invention;

FIGS. 8A-8K illustrate components of the virtual reality system shown in FIG. 8′;

FIGS. 9 and 9′ illustrate schematic of a virtual reality system according to an embodiment of the present invention;

FIGS. 9A-9C illustrate components of the virtual reality system shown in FIG. 8′;

FIG. 10 illustrates a schematic of a virtual reality system according to an embodiment of the present invention;

FIG. 11 illustrates a virtual reality system using local networking according to an embodiment of the present invention;

FIG. 12 illustrates a virtual reality system using local and Wide Area networking according to an embodiment of the present invention;

FIG. 13 illustrates a schematic of the virtual reality system shown in FIG. 10; and

FIG. 13A illustrates components of the virtual reality system shown in FIG. 13.

### DETAILED DESCRIPTION OF PREFERRED EMBODIMENTS

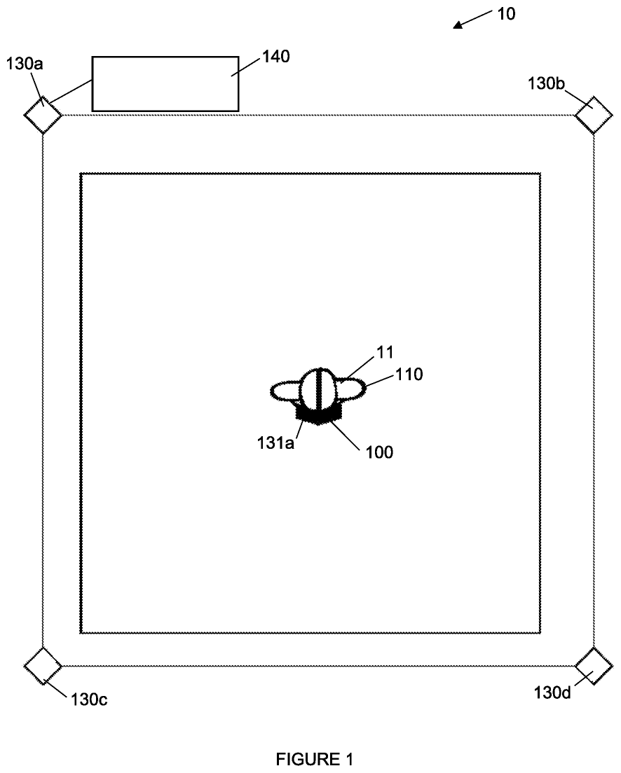

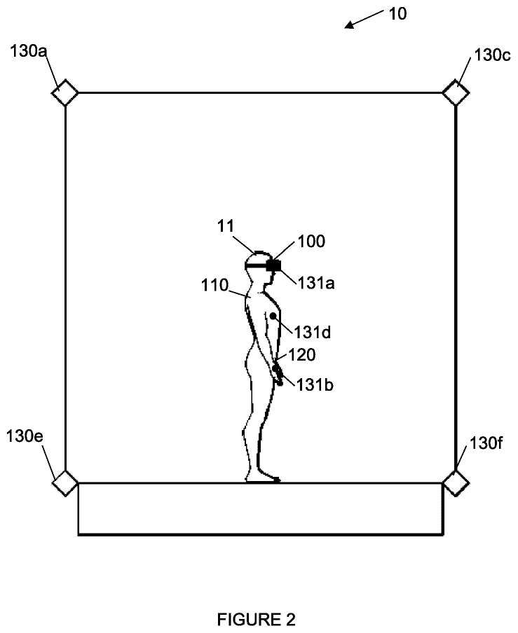

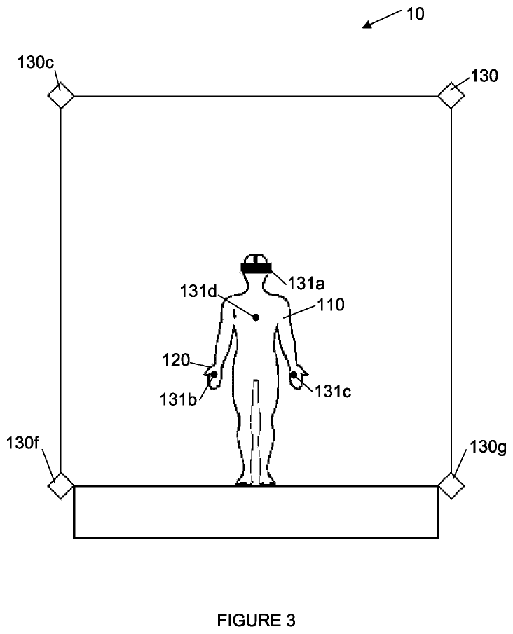

Referring to FIGS. 1-3, there is depicted a virtual reality system 10 which tracks the position and movements of a user according to an embodiment of the present invention.

The system 10 includes a head mounted display 100 (HMD) that is mounted to a user 11 to display a virtual environment to the user 11.

In a preferable embodiment, the HMD 100 has a 180 degree horizontal Field of View and includes eye tracking hardware and software to track eye movement of the user 11 when the HMD 100 is in use. It will be understood that the defined Field of View is not limited to that described and may vary.

The system 10 also includes wearable haptic components in the forms of a full body suit 110 and gloves 120, each having haptic feedback devices integrated therein. It should be appreciated that the full body suit could be interchanged with individual wearable items, such as a haptic vest, trousers and sleeves, for example. In some embodiments, gloves 120 may not have any haptic feedback devices but do have motion capture sensors.

In some embodiments, the full body suit 110 also includes climate feedback devices (or temperature simulation devices) which are capable of simulating climate and temperature conditions, such as generating heat to simulate a desert environment or cooling the suit to simulate a snowy environment, for example.

In some additional or alternative embodiments, the full body suit 110 may also include biometric sensors for monitoring biometric conditions of the user (e.g. heart rate and breathing rate).

While one of the haptic components is described as a full body suit, it should be appreciated that the haptic component could be provided as a two-piece suit (a top half and bottom half, for example) or as multiple pieces to be worn.

The full body suit 110 is adapted to cover the arms, chest, legs and back of a user to provide haptic responses to a substantial portion of the body, including hands and fingers via the gloves 120. This effectively allows the entire skeleton of the user to be tracked and thus recreated accurately in the virtual environment. Advantageously, this allows for more realistic interactions with the virtual environment that can be programmed to respond to the user's movements and actions in a more lifelike way based on the more granular tracking data available. An example of a suitable full body suit is the Teslasuit. The full body suit 110 preferably takes the form of a haptic enabled suit that utilises a network of electrodes within the suit to deliver calibrated electrical currents to the user. Variations in amplitude, frequency and amperage allow for the haptic feedback to be adjusted based on the sensation or feedback required.

The system 10 also includes a tracking system for tracking the movements of the user 11 and generating tracking data. The tracking system allows for the tracking of both the position and the rotation of tracking markers in 3-dimensional space within view of a tracking sensor (such as a camera, for example).

The tracking system may include a number of tracking sub-systems to provide granularity to the tracking performed. In some embodiments, a first tracking sub-system tracks the full body movements and position of the user and the HMD 100 (preferably via tracking markers attached to the body of the user or full body suit 110 and gloves 120. The first tracking sub-system tracks the gross position of the user, including their head, body and limbs.

In a further embodiment, the first tracking sub-system tracks the position of the user by a tracking marker attached to the user and the position of the HMD 100 is also tracked. In such an embodiment, a second tracking sub-system tracks full body suit 110 and gloves 120, which may also include a motion capture assembly or motion capture sensors for tracking the movement of the user. The second tracking sub-system tracks the gross movements and the finer (or more granular) movements of the user, including fingers.

An optional third tracking sub-system tracks movement of the eyes of the user through a device attached to the HMD 100.

The tracking system includes a number of cameras and tracking markers which will now be described. Located about the physical space that the user 11 is located in, are eight sensors in the form of eight cameras 130a-g (in the figures the eighth camera is obscured between 130g) which are configured to sense the position and orientation of four tracking markers (preferably in the form of optical tracking pucks) 131a-d located on the user 11 and the equipment (i.e. head mounted display 110, full body suit 110 and gloves 120) worn by the user 11 which may include additional tracking markers integrated therein. Various arrangements for tracking an object in 3D space are known in the prior art.

The tracking system also includes a base station (not shown) for synchronising the markers and sensors.

System 10 further includes a computer system 140 that is programmed as will be discussed and which is coupled to the tracking system, the wearable haptic components and the head mounted display 100 to receive tracking data and control the virtual environment. In particular, the computer 140 is programmed to generate the virtual environment for display on the HMD 110 and then respond to the tracking system to control the HMD 110 to produce images of the virtual environment corresponding to tracking data from the tracking system and control the wearable haptic components to generate a haptic output or effect in response to tracking data from the tracking system and events in the virtual environment.

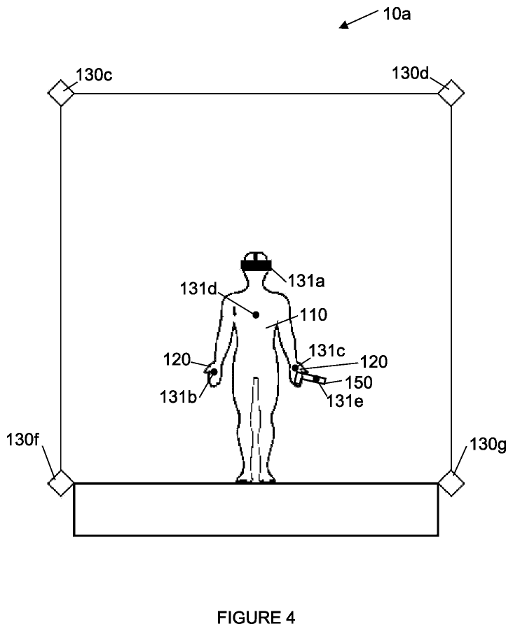

In a second embodiment shown in FIG. 4, a virtual reality system 10a, having the same features as virtual reality system 10 described above, also includes a replica device in the form of a an electromagnetic recoil enabled replica firearm 150. The electromagnetic recoil enabled replica firearm 150 (which is a 1 to 1 scale replica firearm) includes an electromagnetic recoil system to provide physical feedback to a user. In particular, the electromagnetic recoil system of the electromagnetic recoil enabled replica firearm 150 includes a number of sensors to detect certain actions (such as a trigger squeeze, for example) or to detect a selector switch position or charging handle position. While the electromagnetic recoil enabled replica firearm 150 can include an internal battery, external batteries may be provided in the form of magazines having a battery inside (replicating ammunition magazines) that are attached to the electromagnetic recoil enabled replica firearm 150.

In this embodiment, the tracking system additionally includes a fifth tracking marker 131e which is attached to the electromagnetic recoil enabled replica firearm 150 for monitoring the 3D position of the electromagnetic recoil enabled replica firearm 150. In some embodiments, additional tracking markers may be located on the magazine of the electromagnetic recoil enabled replica firearm 150.

It is envisioned that other replica weaponry, tools and peripherals can be used with the virtual reality system described herein. For example, replica weaponry in the form of grenades or flashbangs could be provided. In another example, replica medical equipment could be provided.

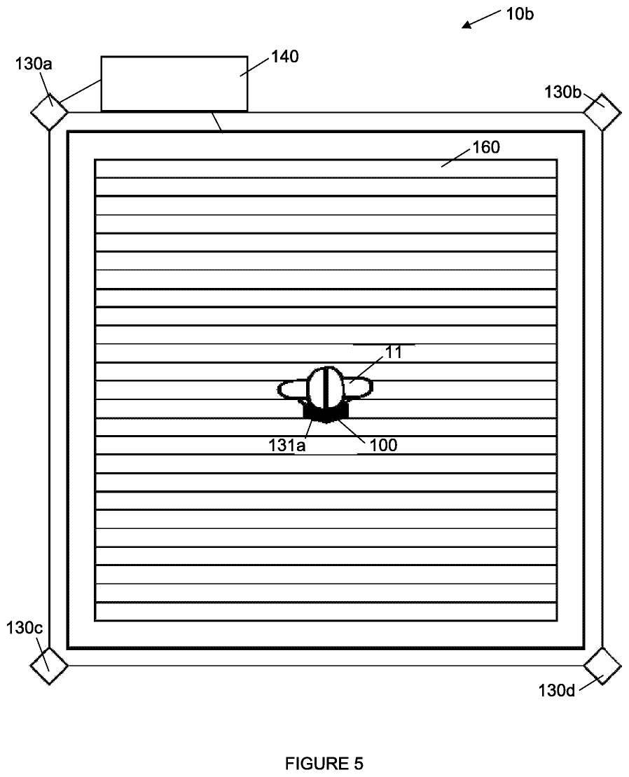

In a third embodiment shown in FIG. 5, a virtual reality system 10b, having the same features as virtual reality system 10 described above, additionally includes an adaptive moving platform in the form of an omnidirectional treadmill 160. The omnidirectional treadmill 160 allows the user 11 to stand on the treadmill 160 and move in any direction by walking, running, crawling, crouching or otherwise without leaving the surface of the treadmill 160 as it reactively moves in response to the user's movements to keep the user substantially centrally located on the treadmill 160. The replica firearm 150, along with any other features described in relation to virtual reality system 10a may also be used with virtual reality system 10b.

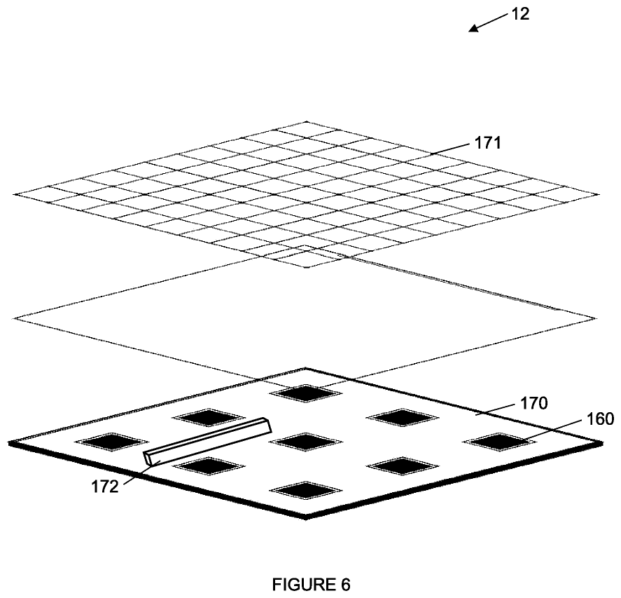

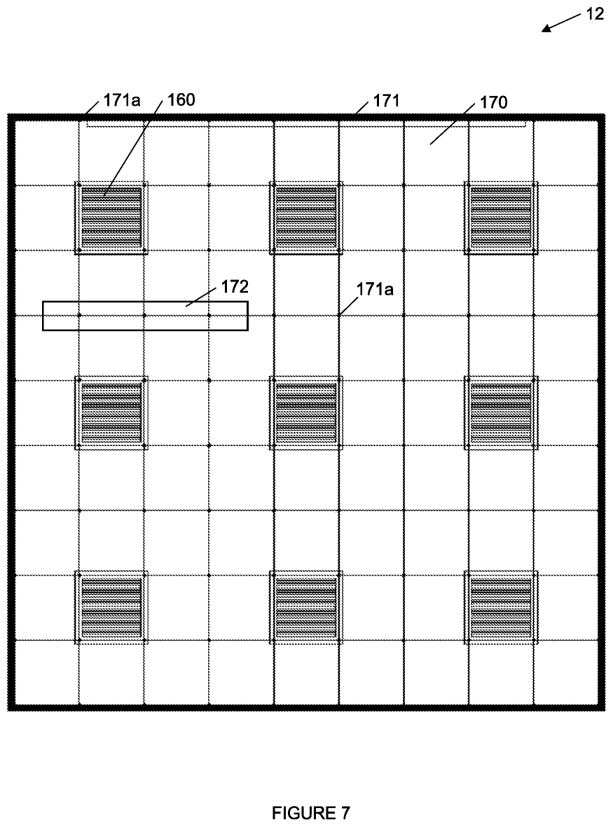

In some further embodiments, the virtual reality system may comprise a physical space 12, shown in an overhead view in FIG. 7 and perspective view in FIG. 6, having both fixed floor components 170 and omnidirectional treadmills 160. In such embodiments, a tracking system 171, substantially similar to the tracking system described in relation to system 10, is implemented to track the movement and positions of users, whether on the fixed floor components 170 or the omnidirectional treadmills 160. However, the tracking system 171 includes an array of one hundred (100) cameras arranged overhead. Each camera is illustrated by one of the plurality of nodes 171a.

Virtual reality system 10 can be utilised within physical space 12 as described herein. It will be appreciated that the omnidirectional treadmills 160 will be networked.

The fixed floor component 170 can include prefabricated structures such as a wall 172 or environmental obstacles such as blockades and mockup mountable vehicles, for example.

The space 12 can also include a marksmanship training interface for the replica firearm 150 or other replica firearms in accordance with embodiments of the invention.

A marksmanship training interface may take the form of a projection system (or a large screen) and a tracking system which tracks the position of lasers upon the projection.

In one embodiment, the marksmanship training interface includes a laser emitter attached to the replica firearm 150 which can be used to train small scale marksmanship and tactics. Imagery displayed on the projections are a virtual environment generated by a graphical engine tool such as Unreal Engine 4, for example.

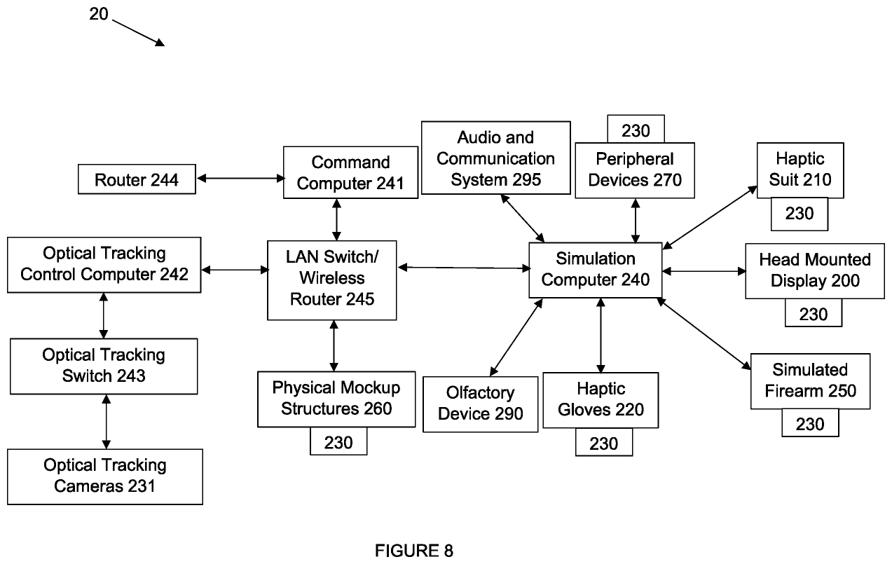

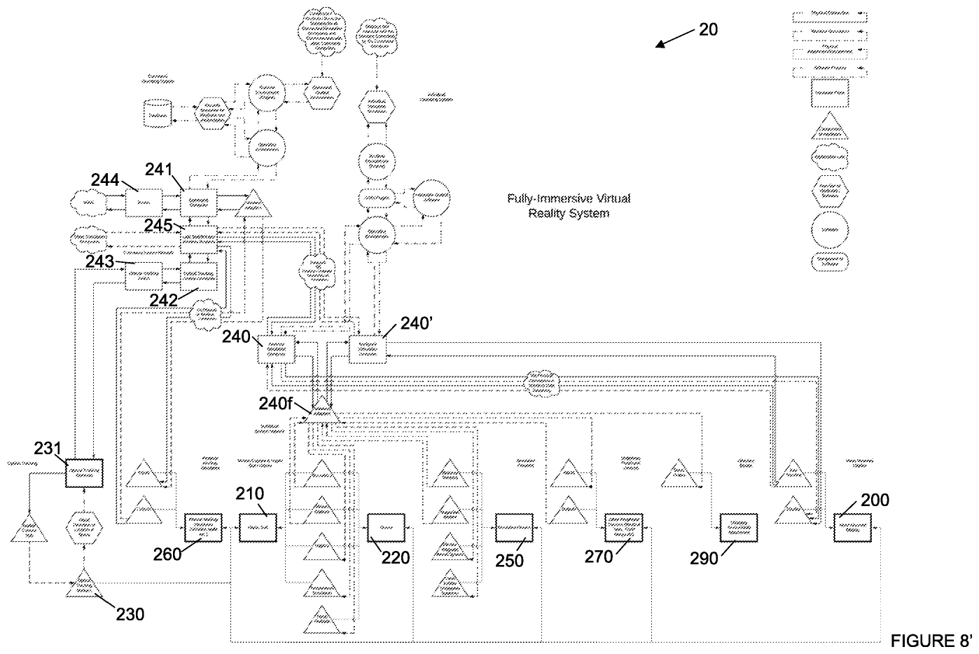

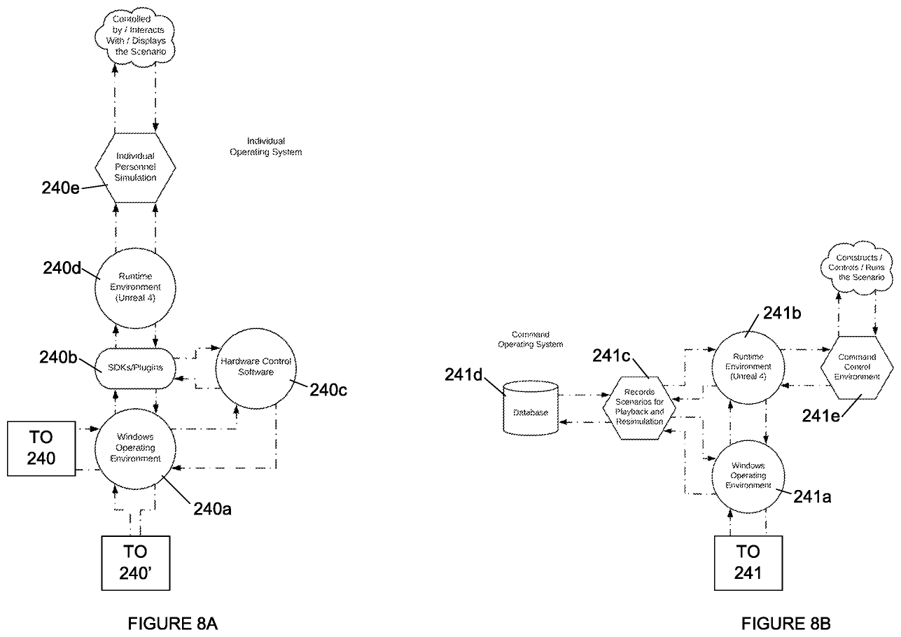

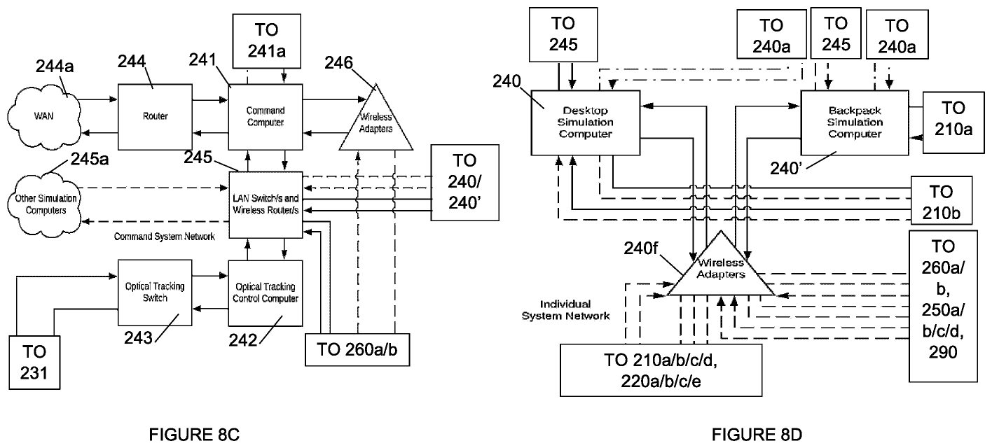

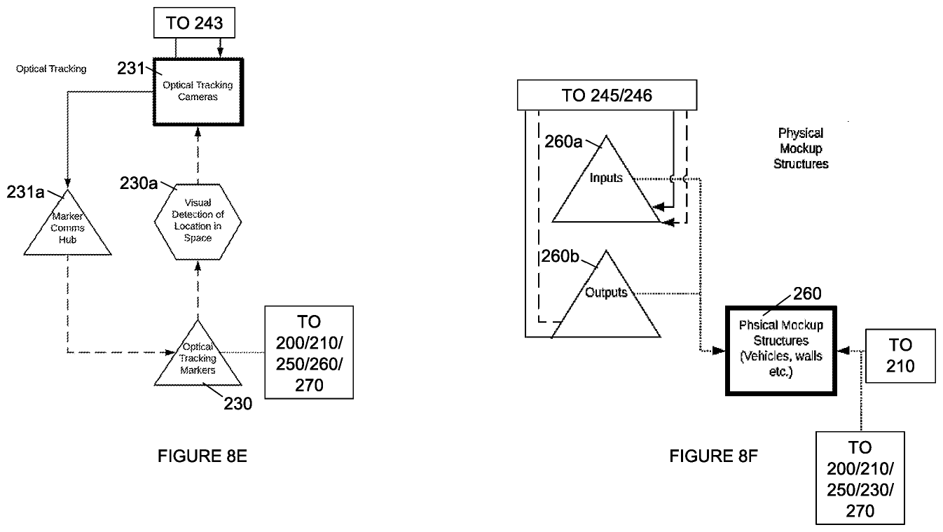

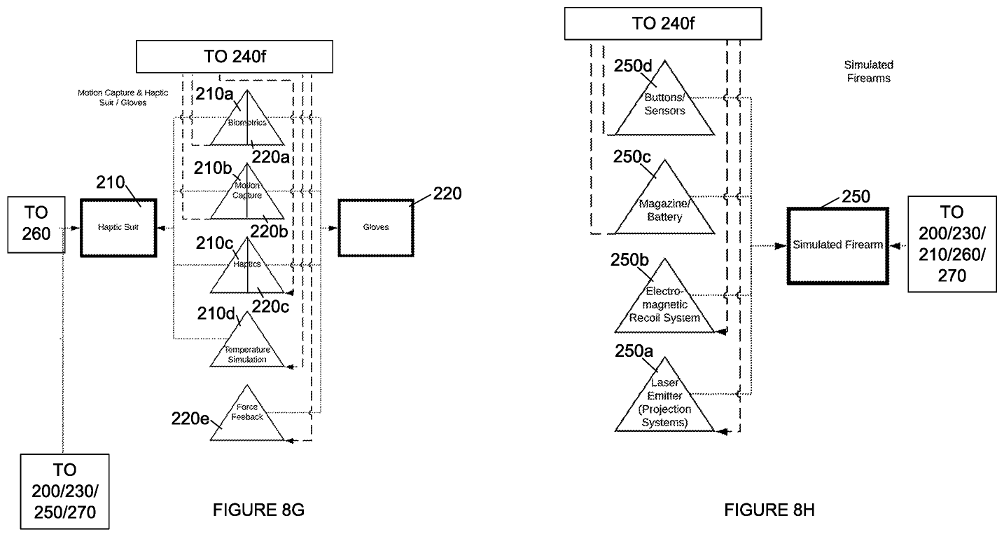

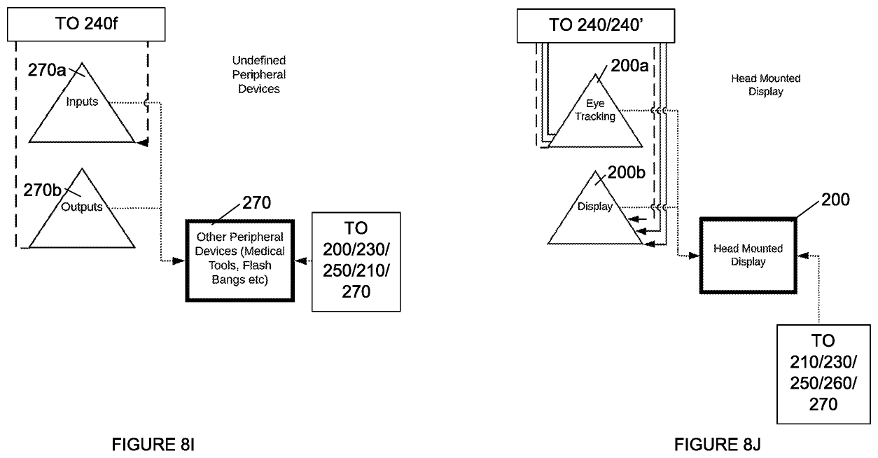

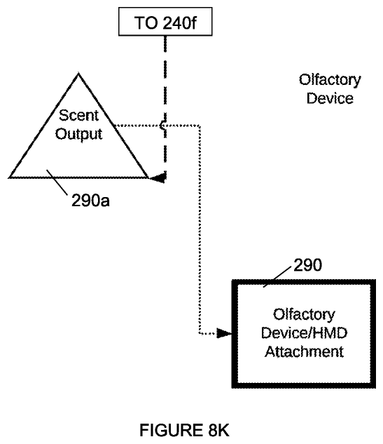

Turning now to FIGS. 8, 8′ and 8A-8J, there are shown hardware and software schematics of virtual reality system 20 according to an embodiment of the present invention.

FIG. 8 illustrates a simplified hardware schematic of the virtual reality system 20, FIG. 8′ illustrates a detailed hardware and software schematic of the virtual reality system 20 and FIGS. 8A-8J illustrate individual elements of the virtual reality system 20 for clarity.

As shown in FIG. 8, virtual reality system 20 includes a head mounted display (HMD) 200, wearable haptic components in the form of a haptic suit 210 and haptic gloves 220, a replica firearm in the form of a simulated firearm 250 (substantially similar to electromagnetic recoil enabled replica firearm 150), physical objects in the form of physical mockup structures 260, additional task specific peripheral devices 270 and an olfactory device 290 in the form of a HMD 200 attachment. Virtual reality system 20 also includes a tracking system in the form of tracking markers 230 and optical tracking cameras 231.

In some further embodiments, the virtual reality system 20 includes an audio and communication system 295 in the form of speakers, headphones and/or a microphone to allow verbal communication between users. The speakers and/or headphones allow actions and events that occur in the virtual environment (possibly in response to actions performed in the physical space with the physical objects and/or replica devices, for example) to have accompanying sounds which further enhance the immersive experience of the system.

In some embodiments, the audio and communication system 295 may be integrated into the HMD 200.

Further to the above, virtual reality system 20 includes a computer system programmed to respond to inputs and data received from various components to generate and control the simulated virtual environment in response to the inputs and data. This will be described in more detail below. The computer system includes a Simulation Computer 240 (in some embodiments, the simulation computer is a Backpack Simulation Computer 240′ worn by the user), a Command Computer 241, an Optical Tracking Control Computer 242, an Optical Tracking Switch 243, a Router 244, a LAN Switch and Wireless Routers 245 and Wireless Adapters 246.

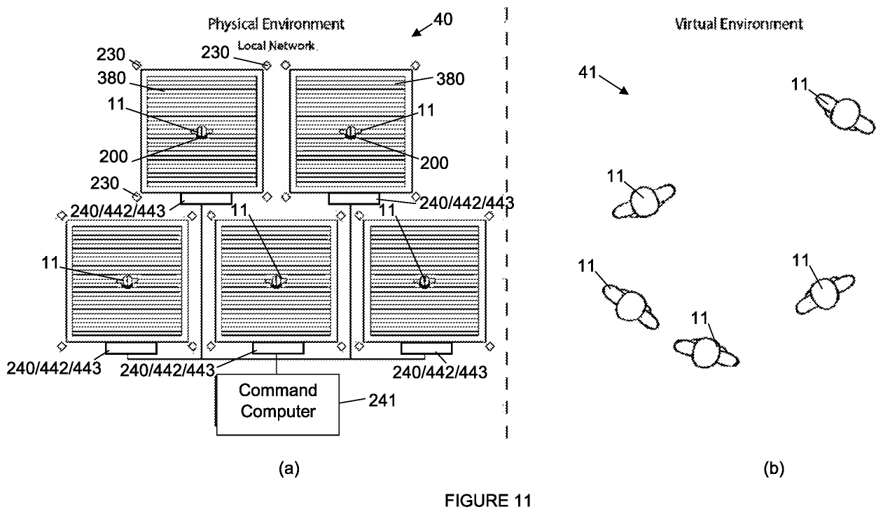

As can be seen, the LAN Switch and Wireless Router 245 and Wireless Adapters 246 network the Command Computer 241, Simulation Computer 240, Optical Tracking Control Computer 242 and Physical Mockup Structures 260 together. The LAN Switch and Wireless Router 245 can also locally network the Simulation Computers of multiple virtual reality systems together for collaborative or multi-person simulations. An example of multiple systems that are locally networked can be seen in FIG. 11.

The Optical Tracking Control Computer 242 is in communication with the Optical Tracking Switch 243 which, in turn, is in communication with the Optical Tracking Cameras 231.

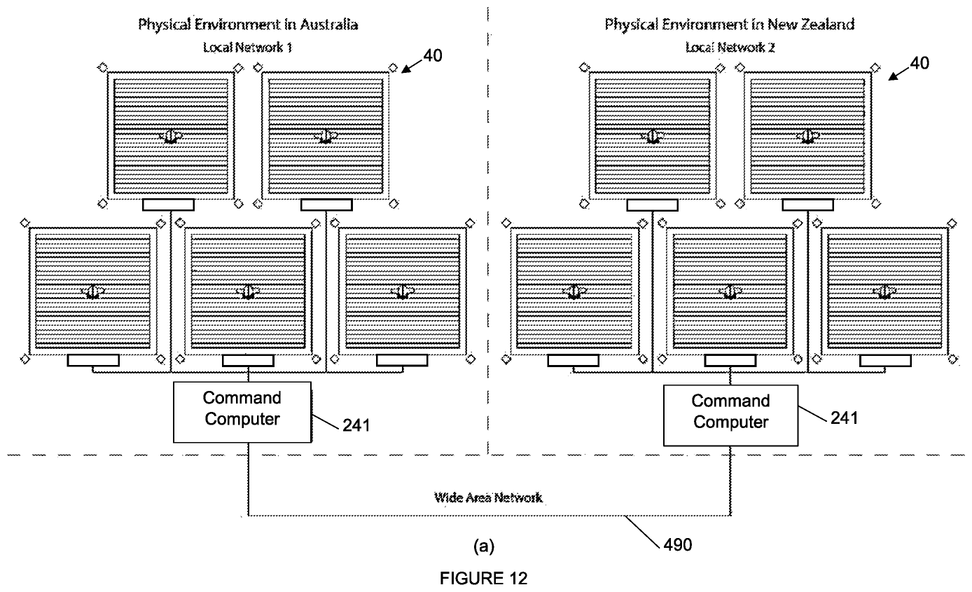

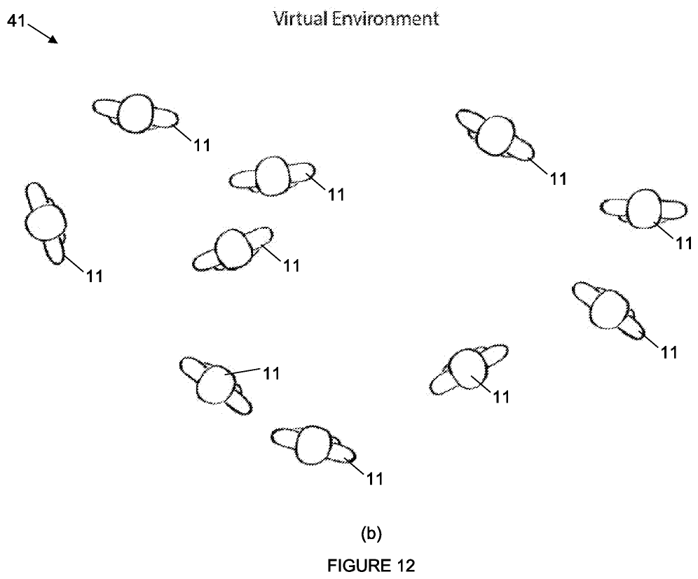

The Command Computer 241 is in communication with Router 244 which may be in communication with other virtual reality systems similar to virtual reality system 20. As shown, the Router 244 is connected to a WAN (Wide Area Network) 244a to allow such networking between systems in relatively remote locations. An example of a WAN networked system is shown in FIG. 12.

Simulation Computer 240 is in communication with each of the Peripheral Devices 270, Haptic Suit 210, HMD 200, Simulated Firearm 250, Haptic Gloves 220, audio and communication system 295 and the olfactory device 290.

The communication between the devices referenced above in relation to virtual reality system 20 may be either wired, wireless or a combination of both, depending on the configuration and requirements of the system.

Turning now to FIG. 8A, there is illustrated the operating system of Simulation Computer 240. The Simulation Computer 240 includes a Windows Operating Environment 240a which executes Software Development Kits (SDKs)/Plugins 240b and Hardware Control Software 240c, which interoperate.

The SDKs/Plugins 240b communicate various data and information received from the various hardware components (HMD 200, Haptic Suit 210, etc.) to the Runtime Environment 240d (in this embodiment, the Runtime Environment is Unreal Engine 4) which, in use, executes and generates the Individual Personnel Simulation 240e. The Runtime Environment 240d also controls the Individual Personnel Simulation 240e in response to the various data and information mentioned above.

Referring to FIG. 8B, the operating system of the Command Computer 241 is shown.

The Command Computer 241 includes a Windows Operating Environment 241a which executes the Runtime Environment 241b (in this embodiment, the Runtime Environment is Unreal Engine 4). In use, the Runtime Environment 241b and Windows Operating System 241a executes function 241c which records scenarios for playback and re-simulation and function 241e which constructs, controls and runs the simulated virtual environment provided by the Simulation Computer 240. The data from function 241c is stored in Database 241d for retrieval and review.

Turning now to FIG. 8C, there is shown a detailed view of a Command System Network comprising the Router 244, Command Computer 241, LAN Switch and Wireless Router 245, Wireless Adapters 246, Optical Tracking Control Computer 242 and Optical Tracking Switch 243 interconnected as described above in relation to FIG. 8.

Moving to FIG. 8D, the details of the Simulation Computer 240 are illustrated. The Simulation Computer 240, including processing, graphics and memory components (not shown), includes a Wireless Adapter 240f (in the form of a wireless transceiver or the like) which communicates with and receives data from the Biometric Sensors 210a, 220a of the respective Haptic Suit 210 and Haptic Gloves 220 and from the Motion Capture Sensors 210b, 220b of the respective Haptic Suit 210 and Haptic Gloves 220.

The Wireless Adapter 240f also communicates with and sends data and instructions to each of the Olfactory Device 290, Haptic Feedback Devices 210c, 220c and Temperature Simulation Devices 210d of the Haptic Suit 210.

The Wireless Adapter 240f is additionally in wireless communication with Force Feedback Device 220e which are exclusive to the Haptic Gloves 220.

In FIG. 8E, the tracking system is shown. The tracking system includes Optical Tracking Cameras 231 and Optical Tracking Markers 230, as described above. In particular, the Optical Tracking Markers 230 are attached to or embedded within each of the HMD 200, Haptic Suit 210, Haptic Gloves 220, Simulated Firearm 250, Physical Mockup Structures 260 and Other Peripheral Devices 270. It will be appreciated that in some embodiments, optical tracking markers are not used with the Haptic Gloves 220.

The Optical Tracking Cameras 231 include a Marker Communications Hub 231a which is in wireless communication with the Optical Tracking Markers 230. In a preferred embodiment, the Optical Tracking Markers 230 comprise active tracking markers as opposed to passive tracking markers. However, it should be appreciated that passive tracking markers can be used, or a combination of both active and passive tracking markers.

In use, the Optical Tracking Cameras 231 optically track the Optical Tracking Markers 230 to visually detect the location of each of the Optical Tracking Markers 230 in physical 3-dimensional space (as indicated at Function 230a).

Moving on to FIG. 8F, the detail of the physical mockup structures 260 is illustrated. The Physical Mockup Structures 260 include Inputs 260a and Outputs 260b. In use, Physical Mockup Structures 260 are setup prior to a simulation being run using the tracking system to map their location. The Physical Mockup Structures 260 are envisioned to replicate objects that a user is likely to encounter in the physical world, such as buildings, walls, doors, windows and the like.

In embodiments where the Physical Mockup Structure 260 are movable or interactable (e.g. doors), the movement of the Physical Mockup Structures 260 is tracked by the tracking system.

The Outputs 260b measure interactions with the Physical Mockup Structures 260 and communicate the measurements (such as keypad and button presses) to LAN Switch and Wireless Router 245 and Wireless Adapters 246 connected to the Simulation Computer 240 and Command Computer 241.

In turn, the Inputs 260a may also receive instructions from the LAN Switch/Wireless Router 245 as processed by the Simulation Computer 240 or Command Computer 241 to control certain aspects of the Physical Mockup Structures 260. For example, the inputs may unlock or lock a door to allow access to a certain area of the virtual environment or trigger a vibration of an object to indicate an event, such as an explosion.

At FIG. 8G, a detailed schematic of the Haptic Suit 210 and Haptic Gloves 220 is shown.

As described above in relation to FIG. 8E and the Wireless Adapter 240f, the Haptic Suit 210 and Haptic Gloves 220 include Biometric Sensors 210a, 220a, Motion Capture Sensors 210b, 220b, and Haptic Feedback Devices 210c and 220c. The Haptic Suit 210 also includes Temperature Simulation Devices 210d. The Haptic Gloves 220 also include Force Feedback Devices 220e.

The Biometric Sensors 210a, 220a and Motion Capture Sensors 210b, 220b receive inputs based on outputs from the user (for the Biometric Sensors 210a, 220a) and physical movement of the user (for the Motion Capture Sensors 210b, 220b). The inputs, as data, are communicated to the Wireless Adapter 240f of the Simulation Computer 240.

Conversely, the Simulation Computer 240, via the Wireless Adapter 240f, communicates with and controls the Haptic Feedback Devices 210c, 220c and Temperature Simulation Devices 210d of the Haptic Suit 210, and the Force Feedback Device 220e of the Haptic Gloves 220.

The Motion Capture Sensors 210b, 220b may comprise a combination of magnetometers, gyroscopes and accelerometers. The Haptic Feedback Devices 210c, 220c may comprise transcutaneous electrical nerve stimulation (TENS) units or Electrical Muscle Stimulation (EMS) units.

For convenience the Biometric Sensors, Motion Capture Sensors and Haptic Feedback Devices are each only shown once in the diagram but are divided in half which indicates that each of the Haptic Suit 210 and the Haptic Gloves 220 has their own sets of these aforementioned devices.

Turning to FIG. 8H, the detailed schematic of the Simulated Firearm 250 is shown.

The Simulated Firearm 250 includes a Laser Emitter Projection System 250a and an Electromagnetic Recoil System 250b which are controlled by, and receive inputs from, the Simulation Computer 240 via Wireless Adapter 240f.

The Simulated Firearm 250 also includes a Magazine (having a battery therein) 250c and Buttons/Sensors 250d (to receive inputs, via a trigger, for example) which communicate with, and transmit data to, the Simulation Computer 240 via Wireless Adapter 240f.

Referring now to FIG. 8I, the schematic detail of the Other Peripheral Devices is illustrated. The Other Peripheral Devices 270 include Inputs 270a and Outputs 270b. The Other Peripheral Devices 270 may take the form of replica flash bangs, medical tools, knives and other scenario specific equipment. In use, the Other Peripheral Devices 270 are equipped with tracking markers (either internally or externally) and may include interactable elements (such as buttons, for example) which communicate Outputs 270b to the Simulation Computer 240.

The Outputs 270b measure interactions and communicate the measurements to Wireless Adapter 240f of the Simulation Computer 240.

In turn, the Inputs 270a receive instructions from the Wireless Adapter 240f as processed by the Simulation Computer 240. The Inputs 270a may enable vibrations emitted from vibration units in the Other Peripheral Devices 270, for example.

In FIG. 8J, the detailed schematic of the HMD 200 is shown.

The HMD 200 includes an Eye Tracking Device 200a to track the movement of a user's eyes during use and a Display 200b for visually displaying the virtual environment. As shown, HMD 200 communicates via a wired connection with Backpack Simulation Computer 240′ or via either a wired or wireless connection with Simulation Computer 240.

In summary, the virtual reality system 20 is configured and operates as follows.

The hardware components, including the Haptic Suit 210, Haptic Gloves 220, the Simulated Firearm 250, HMD 200, audio and communication system 295, Olfactory Device 290 and Other Peripheral Devices 270 are connected to (using a combination of wired connections, such as Ethernet, and wireless connections) and in communication with the Simulation Computer 240 and the Command Computer 241.

As noted above, the tracking system including Optical Tracking Cameras 231 and Tracking Markers 230 are connected to the Optical Tracking Switch 243 which is connected to the Optical Tracking Control Computer 242. The Optical Tracking Control Computer 242 receives and processes the tracking data from the tracking system and communicates the tracking data to the Simulation Computer 240, 240′ and the Command Computer 241.

Using software plugins (i.e. SDKs/Plugins 240b), the hardware components are integrated with Runtime Environment 240d on the Simulation Computer 240.

The Runtime Environment 240d then overlays or integrates the plugins so that they work together and interoperate.

The Runtime Environment 240d then constructs and presents a virtual environment, and creates and executes the interactions between the plugins 240b and the surrounding virtual environments. For example, the Haptic Suit 210 generating the sensation of pain on the front and back of a user's leg if they were to be shot in the leg via an AI controlled combatant in the virtual environment.

While the Simulation Computer 240 controls each individual user's hardware, Command Computer 241, which can be used for networking, controls the layout/variables of simulations in the virtual environment, operates the running of simulations, provides real-time and after-action analytics/review of simulations.

As mentioned above, the Command Computer 241 also enables wide area networking between different command computers, and in turn all of their connected simulation computers, along with other interoperable simulation systems, such as mounted vehicle simulators, for example.

Referring now to FIG. 8K, the schematic detail of the Olfactory Device 290 is illustrated. The Olfactory Device 290, which takes the form of a scent emitting device attached to the HMD 200, includes a Scent Output Device 290a. The Scent Output Device 290a includes one or more scent canisters containing one or more premixed scents. In use, the Scent Output Device 290a receives instructions from the Wireless Adapter 240f as processed by the Simulation Computer 240 based on movements of the user, actions of the user and/or events in the virtual environment to provide an olfactory response. As an example, when the user fires a replica firearm (Simulated Firearm 250, for example), a scent canister of the Olfactory Device 290 will release a predetermined amount of chemical, in a mist or aerosol form, which has been prepared to replicate the smell of a discharged firearm.

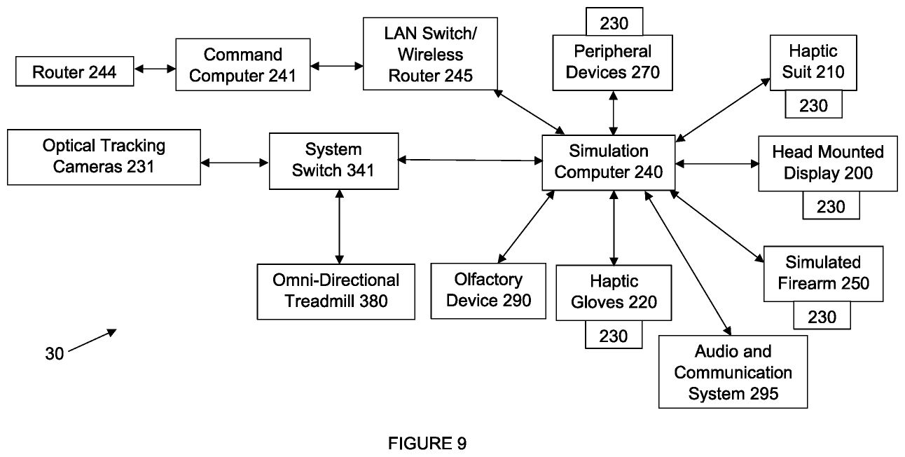

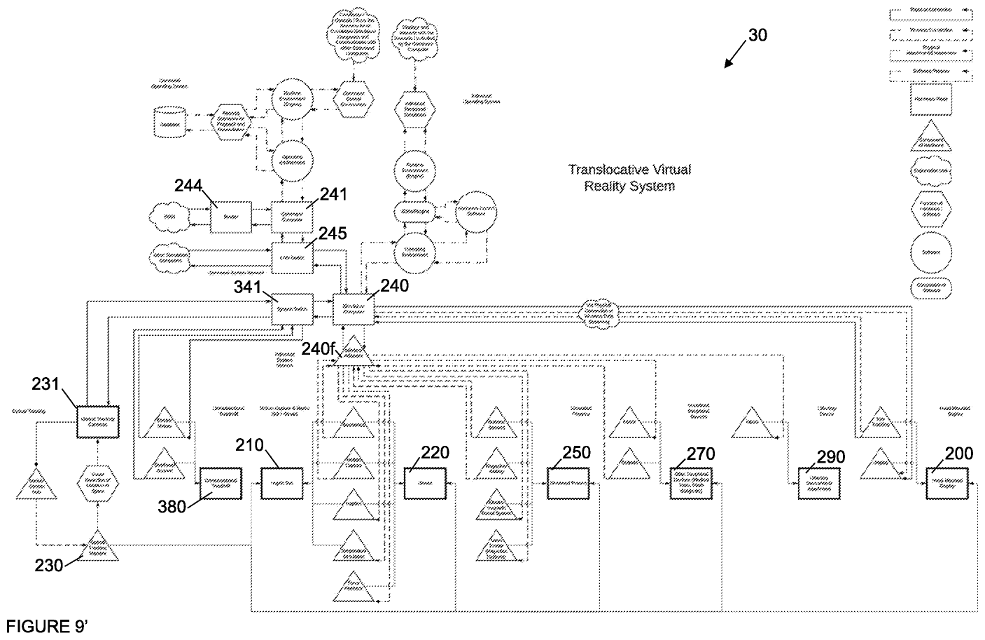

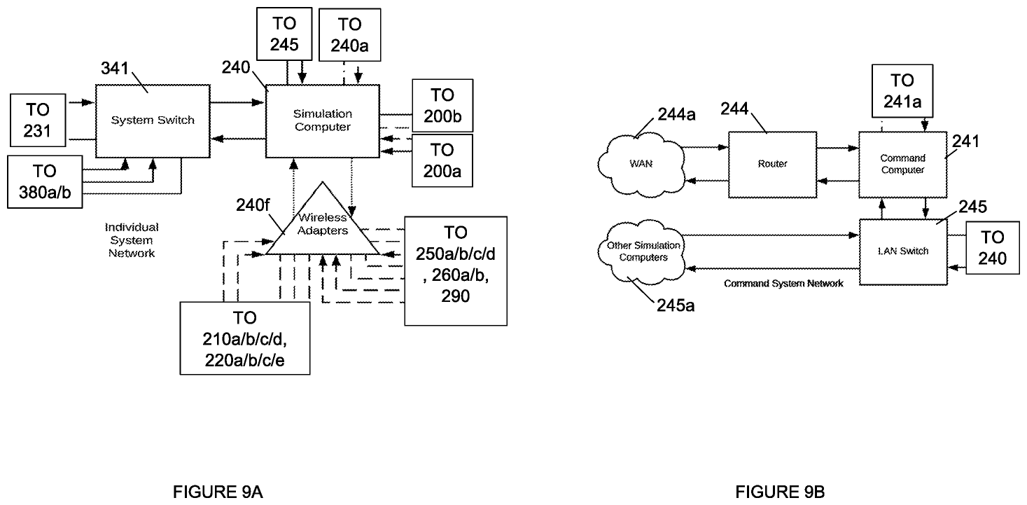

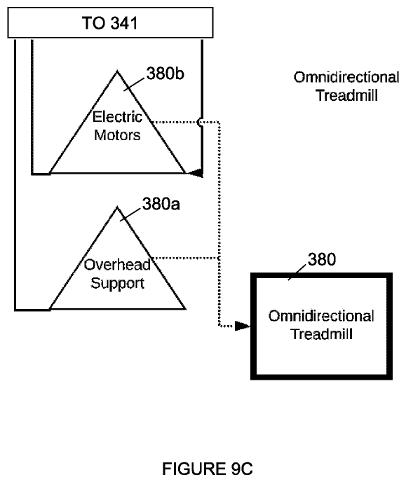

Moving now to FIG. 9, there is shown an alternative embodiment of the present invention in form of virtual reality system 30. Virtual reality system 30 is substantially similar to virtual reality system 20 having all of the same features except the Optical Tracking Control Computer 242, Optical Tracking Switch 243 and Physical Mockup Structures 260 are omitted and replaced with a System Switch 341 and an Omnidirectional Treadmill 380, which will be explained in more detail below. The Omnidirectional Treadmill 380 is substantially similar to Omnidirectional Treadmill 160 described above in relation to virtual reality system 10b.

Virtual reality system 30 also includes audio and communication system 295 in the form of speakers, headphones and/or a microphone to allow verbal communication between users. The speakers and/or headphones allow actions and events that occur in the virtual environment (possibly in response to actions performed in the physical space with the physical objects and/or replica devices, for example) to have accompanying sounds which further enhance the immersive experience of the system.

FIG. 9′ illustrates a detailed hardware and software schematic of the virtual reality system 30 and FIGS. 9A-C illustrate close up schematics of some of the components and systems of the virtual reality system 30.

FIG. 9A illustrates the individual system network of the virtual reality system 30. Simulation Computer 240 is connected to System Switch 341 and includes Wireless Adapter 240f, as previously described. As noted above, virtual reality system 30 omits Optical Tracking Control Computer 242 and Optical Tracking Switch 243 which were present in virtual reality system 20. The Simulation Computer 240 now incorporates the features and roles of the Optical Tracking Control Computer 242, and System Switch 341 replaces Optical Tracking Switch 243 in this particular embodiment.

In this embodiment, System Switch 341 is in communication with the Optical Tracking Cameras 231 and the Overhead Support 380a and Electric Motors 380b of the Omnidirectional Treadmill 380.

Turning to FIG. 9B, it can be seen that the LAN Switch 245 now communicates directly with Simulation Computer 240.

Moving on to FIG. 9C, the detail of the Omnidirectional Treadmill 280 is illustrated. The Omnidirectional Treadmill 280 includes an Overhead Support Module 380a and Electric Motors 380b. The Overhead Support Module 380a attaches to the Omnidirectional Treadmill 380 and, in some embodiments, provides positional data from a back mounted support to indicate user movements.

The Overhead Support Module 380a is connected to System Switch 341 which relays data from the Overhead Support Module 380a to the Simulation Computer 240.

In some further embodiments, an Overhead Support Module may be configured to impart a force (via a force feedback mechanism or the like) on a user to simulate walking up a gradient.

The Electric Motors 380b are controlled by and receive command instructions from the Simulation Computer 240 via the System Switch 341. For example, in response to data received from the Optical Tracking Cameras 231 which indicates that a user has moved forward, the Simulation Computer 240 will instruct the Electric Motors 380b of the Omnidirectional Treadmill 380 to operate to move the surface of the Omnidirectional Treadmill 380 such that the user is returned to the centre of the surface of the Omnidirectional Treadmill 380.

In summary, the virtual reality system 30 is configured and operates as follows.

The hardware components, including the Haptic Suit 210, Haptic Gloves 220, tracking system including Optical Tracking Cameras 231 and Tracking Markers 230, the Simulated Firearm 250, Omnidirectional Treadmill 380, HMD 200, audio and communication system 295, Olfactory Device 290 and Other Peripheral Devices 270 are connected (using a combination of wired connections, such as Ethernet, and wireless connections) to the Simulation Computer 240 and System Switch 341.

Using software plugins (i.e. SDKs/Plugins 240b), the hardware components are integrated with Runtime Environment 240d on the Simulation Computer 240.

The Runtime Environment 240d then overlays or integrates the plugins so that they work together and interoperate.

The Runtime Environment 240d then constructs and presents a virtual environment, and creates and executes the interactions between the plugins 240b and the surrounding virtual environments. For example, the Haptic Suit 210 generating the sensation of pain on the front and back of a user's leg if they were to be shot in the leg via an AI controlled combatant in the virtual environment.

While the Simulation Computer 240 controls each individual user's hardware, Command Computer 241, which can be used for networking, controls the layout/variables of simulations in the virtual environment, operates the running of simulations, provides real-time and after-action analytics/review of simulations.

As mentioned above, the Command Computer 241 also enables wide area networking between different command computers, and in turn all of their connected simulation computers, along with other interoperable simulation systems, such as mounted vehicle simulators, for example.

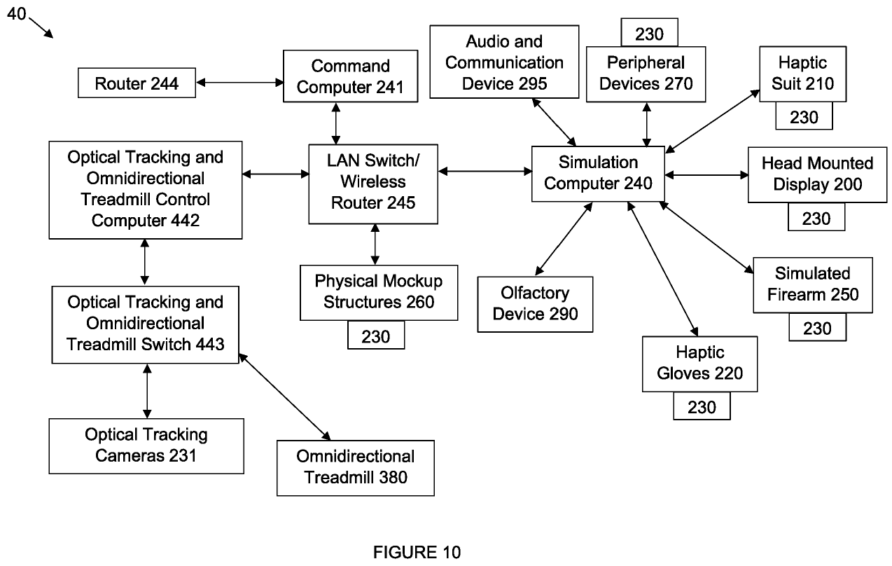

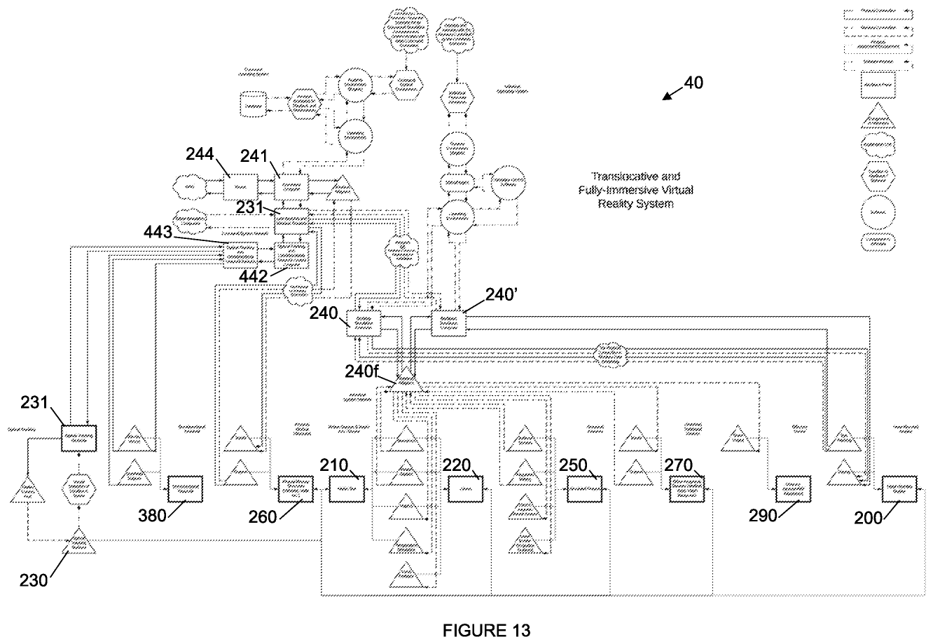

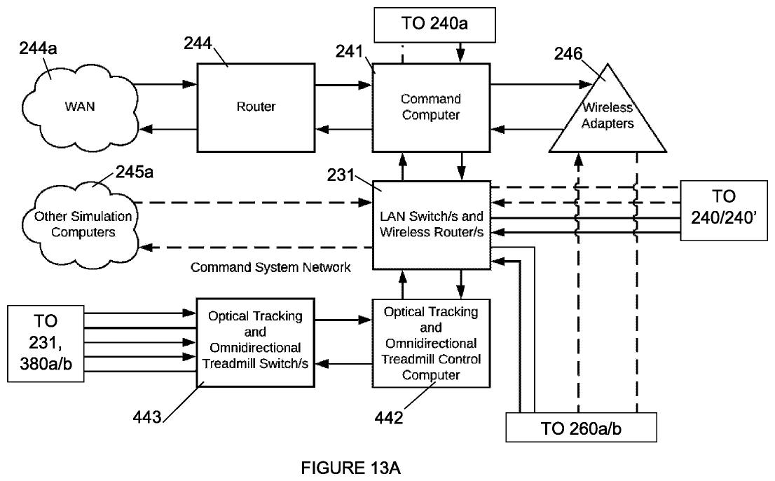

FIGS. 10 and 13 illustrate a hardware schematic of a virtual reality system 40 according to another embodiment of the present invention. Virtual Reality System 40 combines aspects of virtual reality system 20 and virtual reality system 30 described above to include both Physical Mockup Structures 260 and one or more Omnidirectional Treadmills 380.

Virtual reality system 40 replaces the Optical Tracking Control Computer 242 and Optical Tracking Switch 243 with an Optical Tracking and Omnidirectional Treadmill Control Computer 442 and Optical Tracking and Omnidirectional Treadmill Switch 443.

Virtual reality system 40 also includes audio and communication system 295 in the form of speakers, headphones and/or a microphone to allow verbal communication between users. The speakers and/or headphones allow actions and events that occur in the virtual environment (possibly in response to actions performed in the physical space with the physical objects and/or replica devices, for example) to have accompanying sounds which further enhance the immersive experience of the system.

FIGS. 6 and 7 show a physical representation of Virtual Reality System 40 as it may be implemented.

As mentioned above, an example of a locally networked virtual reality system 40 is shown in FIG. 11.

As illustrated, there are a plurality of omnidirectional treadmills 380, each having a user 11 standing thereon. Each user 11 is fitted with a HMD 200 and is tracked by eight overhead optical tracking cameras 231. While not shown, each user 11 is also wearing a haptic suit and haptic gloves, and is fitted with tracking markers which are tracked by the optical tracking cameras 231. While this embodiment, and other embodiments of the present disclosure are described and illustrated as having a specific number of tracking cameras and tracking markers in a tracking system, it should be appreciated that the number of tracking cameras and markers can be easily and readily varied.

Each user 11 may also be equipped with replica firearms (such as replica firearms 150 described above), replica devices, an olfactory device and/or an audio and communication system. The replica devices can take many forms, such as weapons (firearms, guns, knives, grenades, etc), tools (screwdrivers, hammers, etc) medical devices (syringes, scalpels, etc). In some preferable embodiments, the replica devices contrast, the physical objects replicate fixed or permanent objects that the user interacts with. The primary use of the replica devices is to replicate real life situations which is achieved through inputs that replicate the operability of the real version of the device and tracking of the replica device so that the system can provide appropriate feedback through the replica device (where enabled) and the user's haptic components.

The virtual reality system 40 includes Command Computer 241 that is connected to each of the Simulation Computers 240, each of which is in turn connected to a respective HMD 200 haptic suit and haptic gloves. The Simulation Computer 240 may also be connected to other peripheral devices and/or replica devices, such as replica firearms, in some embodiments.

The Simulation Computer 240 of system 40 is also connected to an Optical Tracking and Omnidirectional Treadmill Control Computer 442 connected to an Optical Tracking and Omnidirectional Treadmill Switch 443.

The Optical Tracking and Omnidirectional Treadmill Switch 443 then connects to the respective omnidirectional treadmill 380 and optical tracking cameras 230 to generate and process tracking data from the Optical Tracking Cameras 231 which track the Tracking Markers 230. While the Simulation Computer 240 is shown as directly adjacent each omnidirectional treadmill 380, it will be appreciated that the Simulation Computer 240 could be located underneath the treadmill 380, backpack mounted to be worn by the user 11 or located remotely and in communication with the above devices either wired or wirelessly.

The Simulation Computer 240 is programmed to receive motion capture data from the haptic suits. The Omnidirectional Treadmill Control Computer 442 receives position and movement data from the optical tracking cameras 230 based on their tracking of the tracking markers of each user 11, and movements of the HMD 200 which is communicated to the Simulation Computer 240 to then control the haptic output of the haptic suit and gloves and the operation of the omnidirectional treadmill 380. The Command Computer 241 generates and updates the virtual environment being displayed by the Simulation Computers 240. The Simulation Computers 240 are responsible for controlling the experience of each user 11 in response to their individual actions as well as the actions of others. For example, if one user detonates a grenade, the Simulation Computers 240 may generate haptic feedback to the haptic suits of every user based on their proximity to the detonated grenade to simulate a shockwave.

The Simulation Computer 240 may also receive outputs from various sensors (such as motion capture sensors or biometric sensors) located in the haptic suit and gloves.

While FIG. 11(a) illustrates the virtual reality system 40 as implemented in physical space, FIG. 11(b) illustrates each user 11 as they exist in the virtual environment 41.

Turning to FIGS. 12(a) and 12(b), there is an embodiment of two virtual reality systems 40 networked via a WAN 490. The two virtual reality systems 40 are identical to the virtual reality system 40 described above and shown in FIG. 11 except that the two Command Computers 241 are networked via a WAN 490 to allow users in relatively remote locations (i.e. remote relative to each other) to run simulations as a group and interact in the virtual environment 41.

In one particular use scenario, it is envisioned that the virtual reality systems described herein can be used for training of armed forces without needing to travel to difficult to access locations or organise expensive drills to replicate real-life scenarios. The virtual reality systems are also useful for interoperability with different types of simulators, such as mounted land and air simulators, for example.

Advantageously, embodiments of the invention described herein provide simulated virtual environments that enable dismounted users to freely move about within, interact with and receive feedback from multi-user network environments set on a far larger scale than the physical room or building in which the virtual reality system and users are physically present.

In some further advantages, the use of multiple replica devices and structures adds to the physicality of the system such that it provides a more realistic and immersive experience for a user. For example, the use of the physical mockup structures in combination with the sensory feedback provided by the various feedback devices in addition to the realistic virtual environment provided on the HMD delivers an incredibly realistic experience that very accurately replicates the experience of a user in the real world.

In some further advantages of some embodiments described herein, environments and environmental variables that are not typically readily accessible or controllable (such as deployment zones and civilian presence for example) can be simulated and training drills can be run without endangering users.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step, etc.

The above detailed description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

Throughout the specification and claims (if present), unless the context requires otherwise, the term “substantially” or “about” will be understood to not be limited to the specific value or range qualified by the terms.

1. A virtual reality system comprising:
a head mounted display for producing images of a virtual environment on the display;
a tracking system comprising tracking markers configured to track the movements of a user and the head mounted display, wherein tracking movement of the tracking markers comprises generating position and rotation data corresponding to the movement of the tracking markers;
one or more wearable haptic components for providing haptic feedback;
an omnidirectional treadmill; and
a computer system that is programmed to:
generate a virtual environment for display on the head mounted display and a virtual user in the virtual environment corresponding to the user;
respond to the tracking system and thereby control the head mounted display and virtual user movements to produce images of the virtual environment corresponding to tracking data from the tracking system;
control the one or more haptic components to generate a haptic effect in response to the tracking data from the tracking system and events in the virtual environment; and
control the omnidirectional treadmill in response to the tracking data from the tracking system to keep the user substantially centred on the omnidirectional treadmill.

2. (canceled)

3. The system of claim 1, further comprising a replica device, wherein the tracking system is further configured to track the movements of the replica device, and the computer system is further programmed to communicate with the replica device to thereby receive signals from the replica device and control the replica device in response to the signals and events in the virtual environment.

4. The system of claim 3, wherein the tracking system comprises:
at least three tracking markers, wherein a first tracking marker is attachable to a user, a second tracking marker is attached to the replica device and a third tracking marker is attached to the head mounted display; and
one or more sensors configured to track the at least three tracking markers to generate tracking data corresponding to position and movement of the tracking markers.

5. (canceled)

6. The system of claim 1, wherein the one or more wearable haptic components comprise a full body suit and/or gloves, each having haptic feedback devices integrated therein, wherein the full body suit is adapted to cover the arms, chest, legs and back of a user and the tracking system is configured to track at least one of the arms, torso, legs and fingers of the user.

7. The system of claim 6, wherein the tracking system is configured to track each of the arms, torso, legs and fingers of the user.

8. The system of claim 1, wherein the one or more wearable haptic components further comprise at least one of:
biometric sensors, wherein the computer system is programmed to receive biometric data from the biometric sensors and the computer system is programmed to control the virtual environment in response to the biometric data;
motion capture sensors, wherein the computer system is programmed to receive motion capture data from the motion capture sensors of the one or more wearable haptic components and the computer system is programmed to control the virtual environment in response to the motion capture data;
temperature simulation devices configured to generate heat and/or cold, wherein the computer system is programmed to control the temperature simulation devices in response to tracking data and events in the virtual environment; and
force feedback devices, wherein the computer system is programmed to control the force feedback device in response to tracking data and events in the virtual environment.

9. The system of claim 1, wherein the replica device comprises a replica firearm comprising an electromagnetic recoil system.

10. The system of claim 1, wherein the replica device comprises a replica flashbang and/or replica medical tool having electronic inputs and outputs.

11. The system of claim 4, wherein the tracking markers comprise active optical tracking markers or pucks.

12. The system of claim 1, wherein the tracking system is further configured to track eye movements of a user wearing the head mounted display, wherein the eye movements are tracked via the head mounted display.

13. The system of claim 1, wherein the system comprises one or more physical objects in a physical space and the one or more physical objects comprise one or more tracking markers attached thereto, wherein the tracking system tracks the tracking markers attached to the physical objects and the computer system generates virtual objects in the virtual environment corresponding to the one or more physical objects in the physical space and the computer system is further configured to:
detect user interaction with the physical objects from the tracking data and control the one or more wearable haptic components in response to the user interaction and control the virtual objects in the virtual environment in response to events in the physical space and the user interaction; or
detect user interaction with the virtual objects in the virtual environment and control the one or more wearable haptic components in response to the user interaction and control the physical objects in the physical space in response to events in the virtual environment.

14. The system of claim 1, wherein the system further comprises an olfactory device attached to the head mounted display, the olfactory device being configured to emit one or more scents in response to user movements and/or events in the virtual environment.

15. The system of claim 1, wherein the tracking system comprises a plurality of tracking sub-systems, the plurality of tracking sub-systems comprising a first tracking sub-system configured to track the head mounted display and the movement and position of the user and/or a second tracking sub-system configured to track movement of the one or more wearable haptic components and/or a third tracking sub-system configured to track eye movements of the user.

16. The system of claim 1 wherein the system is networked with a second virtual reality system and wherein the networked virtual reality systems provide a shared virtual environment.

17. A method for controlling a virtual reality system, the method comprising:
generating a virtual environment and a virtual user in the virtual environment based on a user in a physical space;
tracking a three dimensional position of the user in the physical space through tracking markers associated with the user;
generating position and rotation data corresponding to the movement of the tracking markers;
tracking movement of the user on an omnidirectional treadmill interacting with the virtual environment;
controlling the omnidirectional treadmill in response to the movement of the user to keep the user substantially centred on the omnidirectional treadmill;
generating tracking data associated with the three dimensional position of the user in the physical space;
controlling virtual user movements and the virtual environment to produce images of the virtual environment corresponding to the tracking data; and
controlling one or more wearable haptic components worn by the user to generate a haptic effect in response to the tracking data from the tracking system and events in the virtual environment.

18. (canceled)

19. The method of claim 17, further comprising:
tracking a three dimensional position of a replica device and/or a physical object;
generating second tracking data associated with the replica device and/or the physical object and receiving signals from the replica device and/or the physical object;
detecting user interaction with at least one of the replica device, the physical object and elements of the virtual environment based on the second tracking data;
controlling the replica device and/or the physical object in response to the second tracking data, the received signals and the user interaction; and
controlling the virtual environment in response to the second tracking data, the received signals and the user interaction.

20. The method of claim 18 further comprising controlling one or more wearable haptic components worn by the user to generate a haptic effect in response to the second tracking data from the tracking system and the user interaction.

21. A virtual reality system comprising:
a head mounted display for producing images of a virtual environment on the display;
a tracking system comprising tracking markers configured to track the movements of a user and the head mounted display, wherein tracking movement of the tracking markers comprises generating position and rotation data corresponding to the movement of the tracking markers;
an omnidirectional treadmill; and
a computer system that is programmed to:
generate a virtual environment for display on the head mounted display and a virtual user in the virtual environment corresponding to the user;
respond to the tracking system and thereby control the head mounted display and virtual user movements to produce images of the virtual environment corresponding to tracking data from the tracking system; and
control the omnidirectional treadmill in response to the tracking data from the tracking system to keep the user substantially centred on the omnidirectional treadmill.

22. The system of claim 1, wherein the system comprises a support system for supporting a user.

23. The system of claim 15, wherein the support system comprises an overhead support system.

24. The system of claim 1, wherein the system comprises an audio and communication system.
